(19) United States
(12) Patent Application Publication
(10) Pub. No.: US 2020/0052645 A1
(43) Pub. Date: Feb. 13, 2020

(54) GALVANIC ISOLATION AND ELECTRICAL CONNECTION ELEMENT FOR PHOTOVOLTAIC INSTALLATIONS AND PHOTOVOLTAIC INSTALLATION COMPRISING SAID ELEMENT

(71) Applicant: AAAG Seros Training, S.L., Barcelona (ES)

(72) Inventor: Gabriel Ros Serrano, Barcelona (ES)

(21) Appl. No.: 16/305,781

(22) PCT Filed: May 30, 2016
(86) PCT No.: PCT/ES2016/070405

§ 371 Date: Nov. 29, 2018

(51) Int. Cl. H02S 30/00; H01R 4/64

(52) U.S. Cl. CPC H02S 30/00; H01R 4/64

(57) ABSTRACT

A galvanic isolation and electrical connection piece for photovoltaic facilities can be arranged between two metal parts of a photovoltaic facility, and is formed from a main body made of electrically non-conducting material, which includes at least one electrical connector that passes through the main body. It enables the separation of the metal parts of a photovoltaic facility to prevent corrosion thereof and, at the same time, the electric connector enables the electrical connection of the metal parts so as to comply with the safety regulations currently in force.

### FIELD OF THE INVENTION

The present invention relates to a galvanic isolation and electrical connection piece for photovoltaic facilities, which allows galvanic isolation and electrical continuity between different metals present in a photovoltaic facility.

### BACKGROUND OF THE INVENTION

Currently known photovoltaic facilities comprise a support structure in the form of a metal profile, whereon photovoltaic modules, also metallic, are fixed.

A common problem of these currently known photovoltaic facilities is that the contact between the different metal components causes corrosion in their joints, with the ensuing degradation thereof, shortening the useful life of the photovoltaic facilities. This shortening of the useful life of these facilities has a significant effect on the cost thereof, as well as the efficiency of the plant in relation to its calculated life, since it can be shortened and, as a result, reduce the amount of energy produced during the aforementioned useful life.

Furthermore, the recently modified regulation for photovoltaic facilities, particularly standards IEC 61215 and IEC 61730, requires that all the metal parts of the photovoltaic facility be electrically connected for electrical safety reasons. Therefore, this mandatory electrical connection between the metal parts makes it difficult to prevent the aforementioned corrosion problems.

### SUMMARY OF THE INVENTION

The galvanic isolation piece of the invention makes it possible to solve corrosion problems and, simultaneously, enables the electrical between the metal parts. The galvanic isolation piece can easily be assembled in pre-existing photovoltaic facilities, such that they can adapt to current regulations and comply therewith in a very simple and economic manner.

The galvanic isolation piece for photovoltaic facilities according to an aspect of the present invention, can be arranged between two metal parts of a photovoltaic facility, and is characterised in that it is formed from a main body made of an electrically non-conducting material, which comprises at least one electric connector that passes through the main body.

This characteristic enables the separation of the metal parts of a photovoltaic facility to avoid its corrosion and, at the same time, the electrical connector enables the electrical connection of the metal parts so as to comply with the safety regulations currently in force.

Optionally, the electrically non-conducting material is a polymer, with the possibility of choosing between any appropriate conventional polymer for this purpose.

In accordance with a preferred embodiment, the main body is U-shaped, although it could take on other shapes, in a plan view, allowing the passage of a fixing element through the arms of the U.

Optionally, the at least one electrical connector is housed inside a through hole of the main body and, for example, the electrical connector may be a metal pin.

If desired, the galvanic isolation piece may also comprise a coupling element, such as a nut.

In accordance with a possible embodiment, the galvanic isolation piece may comprise an additional body joined to the main body, constituting a single body defining a slot therebetween, wherein a metal part of a photovoltaic facility can be housed. In this case, the coupling element is advantageously disposed in the additional body.

The present invention also relates to a photovoltaic facility that comprises a galvanic isolation piece as previously defined, installed between a support structure and a frame of a photovoltaic module.

For example, the support structure and the frame of a photovoltaic module are fixed to each other by means of at least one fixing screw with the interposition of the galvanic isolation piece.

These and other objects, advantages and features of the invention will become apparent upon review of the following specification in conjunction with the drawings.

### BRIEF DESCRIPTION OF THE DRAWINGS

In order to help make the foregoing more readily understandable, the description is accompanied by a set of drawings which, schematically and only by way of illustration and not limitation, represent a practical case of embodiment.

FIG. 1 is a plan view of a galvanic isolation piece in accordance with a first embodiment of the present invention;

FIG. 2 is a sectional view of the galvanic isolation piece in accordance with the first embodiment of the present invention assembled in a photovoltaic facility, specifically between the support structure and the frame of a photovoltaic module;

FIG. 3 is a plan view of a galvanic isolation piece in accordance with a second embodiment of the present invention; and

FIG. 4 is a sectional view of the galvanic isolation piece in accordance with the second embodiment of the present invention mounted in a photovoltaic facility, specifically between the support structure and the frame of a photovoltaic module.

### DESCRIPTION OF THE PREFERRED EMBODIMENTS

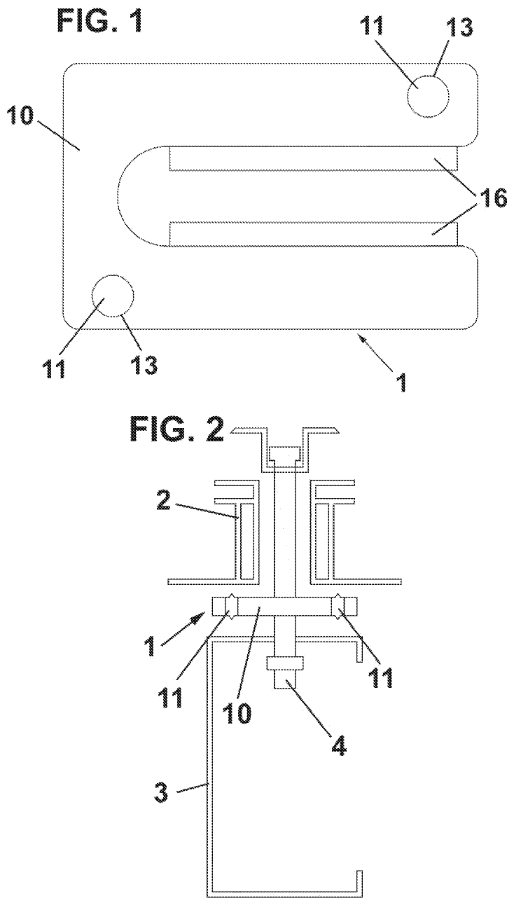

FIGS. 1 and 2 show a first embodiment of the galvanic isolation piece, indicated in general by reference number 1, in accordance with a first embodiment of the present invention.

This galvanic isolation piece 1 is formed by a main body 10 of an electrically non-conducting material, for example, polymer material, which enables the effective separation of two metal parts of a photovoltaic facility, avoiding corrosion between the two parts due to the direct metal contact therebetween. In the illustrated embodiment, the metal parts are a support structure 3 and a frame 2 for a photovoltaic module.

In order to fulfil the requirements of the current regulations governing photovoltaic facilities, the galvanic isolation piece 1 comprises at least one electrical connector 11 that passes through the main body 10. In particular, the electrical connector 11 may be a metal pin housed in a through hole 13 of the main body 10.

The function of the electrical connector 11 is to electrically connect the two metal parts 2, 3 for electrical safety reasons, as required by current regulations.

It should be noted that the number of electrical connectors 11 may be any appropriate number. For example, in the embodiment represented, the galvanic isolation piece 1 comprises two electrical connectors 11.

As can be observed in FIG. 1, the main body 10 has a U-shaped plan view. In this manner, a fixing screw 4 is arranged between the arms of the U in order to fix the metal parts 2, 3 to each other, as can be observed in FIG. 2. In order to facilitate the arrangement of the fixing screw 4, the arms of the U comprise tongues 16 on the inner part thereof, as can be observed in FIG. 1.

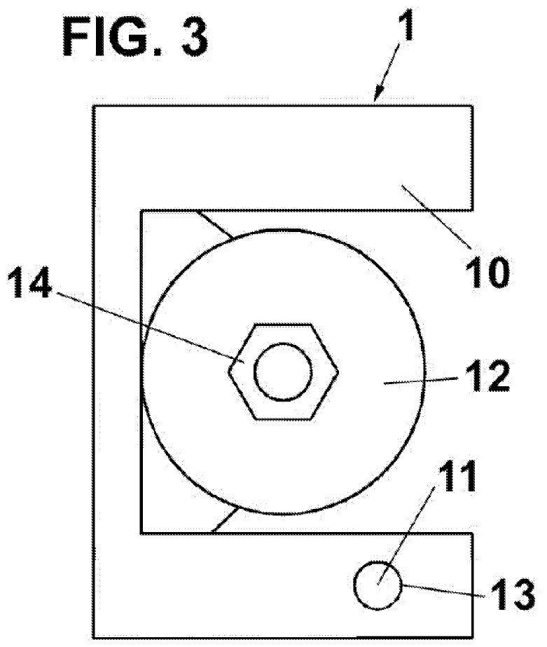

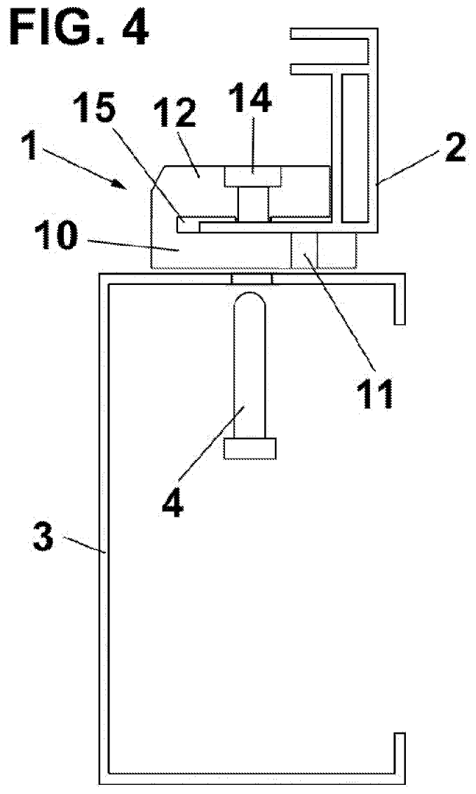

FIGS. 3 and 4 show a second embodiment of the galvanic isolation piece 1 in accordance with the present invention. For the sake of clarity and simplicity, in this second embodiment the same reference numbers are used to identify elements equivalent to the first embodiment. In addition, only the differences with respect to the first embodiment shall be explained.

In this second embodiment, the galvanic isolation piece 1 comprises an additional body 12 joined to the main body 10, defining a slot 15 wherein a metal part 2 of the photovoltaic facility can be housed.

Additionally, in this embodiment, the galvanic isolation piece 1 comprises a coupling element 14, for example a nut, that is preferably inserted in the additional body 12, as can be observed in FIGS. 3 and 4. In addition, in this case, the fixation between the metal parts 2, 3 is carried out by means of a fixing screw 4.

The geometry of the piece 1 in accordance with the present invention enables it to be used both in newly built facilities and in existing facilities, to which electrical continuity must be provided in order to adapt to current regulations, which are much more stringent than the previous regulations.

For its use in existing plants, it is only necessary to loosen the fixing screw 14, insert the piece 1 laterally and re-tighten the screw 14. This will enable the electrical union of modules 2 and structure 3, without need to disassemble the facility, with the ensuing loss of production thereof.

Therefore, it is a useful and feasible solution, both for the plant owner and for the financial institution that contributes the economic means for its construction, since it ensures more reliable long-term returns, due to not having to carry out subsequent repairs to transfer the plant to third parties, which is very common.

Despite the fact that reference has been made to a specific embodiment of the invention, it is evident for the person skilled in the art that the described galvanic isolation piece is susceptible of many variations and modifications, and that all the aforementioned details may be substituted for other, technically equivalent ones without detracting from the scope of protection defined by the attached claims. Thus, it will be appreciated that changes and modifications in the specifically-described embodiments may be carried out without departing from the principles of the present invention, which is intended to be limited only by the scope of the appended claims as interpreted according to the principles of patent law including the doctrine of equivalents.

1. A galvanic isolation and electrical connection piece for photovoltaic facilities, configured to be arranged between two metal parts of a photovoltaic facility, wherein said galvanic isolation and electrical connection piece comprises a main body made of electrically non-conducting material and at least one electrical connector that passes through said main body.

2. The galvanic isolation and electrical connection piece of claim 1, wherein said electrically non-conducting material comprises a polymer.

3. The galvanic isolation and electrical connection piece of claim 1, wherein said main body is U-shaped.

4. The galvanic isolation and electrical connection piece of claim 1, wherein said at least one electrical connector is housed in a through hole of said main body.

5. The galvanic isolation and electrical connection piece of claim 1, wherein said electrical connector comprises a metal pin.

6. The galvanic isolation and electrical connection piece of claim 1, further comprising a coupling element.

7. The galvanic isolation and electrical connection piece of claim 6, wherein said coupling element is a nut.

8. The galvanic isolation and electrical connection piece of claim 1, comprising an additional body joined to said main body, said main body and said additional body cooperating to define a slot therebetween wherein a metal part of a photovoltaic facility can be housed in said slot.

9. The galvanic isolation and electrical connection piece, further comprising a coupling element is arranged in said additional body.

10. A photovoltaic facility comprising said galvanic isolation and electrical connection piece of claim 1, said photovoltaic facility comprising a photovoltaic module including a support structure and a frame, wherein said galvanic isolation and electrical connection piece is mounted between said support structure and said frame of said photovoltaic module.

11. The photovoltaic facility of claim 10, wherein said support structure and said frame of said photovoltaic module are fixed together by at least one fixing screw with the interposition of said galvanic isolation and electrical connection piece.
